(19) United States
(12) Patent Application Publication
(10) Pub. No.: US 2016/0147462 A1
(43) Pub. Date: May 26, 2016

(54) VARIED PRIORITIZATION OF HARD DRIVE STORAGE REGIONS

(71) Applicant: HGST NETHERLANDS B.V., Amsterdam (NL)

(72) Inventor: Christopher Squires, Boulder, CO (US)

(21) Appl. No.: 14/554,259

(22) Filed: Nov. 26, 2014

(51) Int. Cl. G06F 3/06

(52) U.S. Cl. CPC G06F 3/0611; G06F 3/0644; G06F 3/0653; G06F 3/0658; G06F 3/0676

(57) ABSTRACT

To provide enhanced operation of data storage devices and systems, various systems, apparatuses, methods, and software are provided herein. In a first example, a data storage device is provided. The data storage device includes storage media that stores data, and a storage control system configured to identify a region of the storage media as a hot region which is given priority for read operations occurring in the data storage device. The storage control system configured to monitor for a storage event associated with the hot region, and responsive to an occurrence of at least the storage event, the storage control system configured to select another region of the storage media as the hot region.

### TECHNICAL FIELD

Aspects of the disclosure are related to the field of data storage and hard disk drives in data storage systems.

### TECHNICAL BACKGROUND

Computer and network systems such as personal computers, workstations, server systems, and cloud storage systems, typically include data storage systems for storing and retrieving data. These data storage systems can include data storage devices, such as hard disk drives, solid state storage devices, tape storage devices, and other mass storage devices.

To read and write data to rotating media storage drives, such as hard disk drives, a read/write head is employed to magnetically read and write to a disk platter. This read/write head is typically positioned on a movable armature which is angularly positioned across the platter in response to data operations. However, when data operations are spread across the surface of a platter, the armature holding the read/write head can be forced to make many movements to read or write the associated data. This can lead to increased latency and other slowdowns for the performance of the data storage drive.

### OVERVIEW

To provide enhanced operation of data storage devices and systems, various systems, apparatuses, methods, and software are provided herein. In a first example, a data storage device is provided. The data storage device includes storage media that stores data, and a storage control system configured to identify a region of the storage media as a hot region which is given priority for read operations occurring in the data storage device. The storage control system configured to monitor for a storage event associated with the hot region, and responsive to occurrence of at least the storage event, the storage control system configured to select another region of the storage media as the hot region.

In another example, a method of operating a data storage device is presented. The method includes storing the data on storage media, identifying a region of the storage media as a hot region which is given priority for read operations occurring in the data storage device, monitoring for a storage event associated with the hot region, and responsive to an occurrence of at least the storage event, selecting another region of the storage media as the hot region.

In another example, a hard disk drive is presented. The hard disk drive includes rotating magnetic storage media configured to store data, and one or more read/write heads positioned over the storage media and configured to at least write the data to the storage media and read the data from the storage media. The hard disk drive also includes a storage control system configured to identify a hot region from among a plurality of concentric storage regions of the storage media for prioritizing read transactions of the hard disk drive by at least loitering the one or more read/write heads over the hot region of the storage media after at least the read transactions and write transactions. The storage control system is configured to change the hot region among the plurality of concentric storage regions of the storage media based upon at least a quantity of the write transactions performed to the hot region.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a data system.

FIG. 2 is a flow diagram illustrating a method of operation of a data storage drive.

FIG. 3 is a system diagram illustrating a data system.

FIG. 4 is a flow diagram illustrating a method of operation of a hard disk drive.

### DETAILED DESCRIPTION

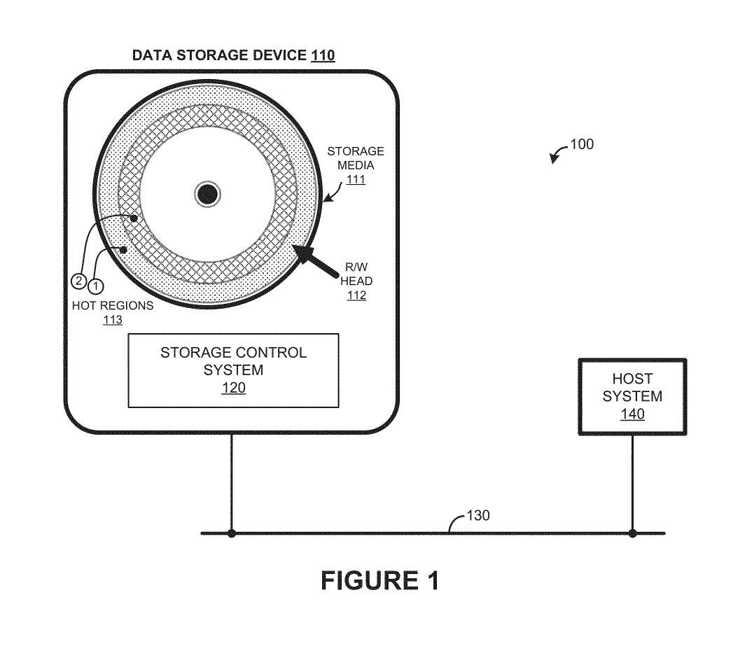

FIG. 1 is a system diagram illustrating data system 100. System 100 includes data storage device 110 and host system 140. Data storage device 110 and host system 140 communicate over storage interface 130. Data storage device 110 includes one or more rotating storage media 111, which can comprise platters of a hard disk drive in some examples. Data storage device 110 also includes storage control system 120 which can control the operations of data storage device 110, among other operations.

In operation, data storage device 110 receives read or write transactions over storage interface 130 issued by host system 140. Responsive to read transactions, data storage device 110 retrieves data stored upon media 111 with read/write (R/W) head 112 for transfer to host system 140. Responsive to write transactions, data storage device 110 stores data onto media 111 with R/W head 112. R/W head 112 is positioned over different areas of media 111 to read or write associated data. It should be understood that other components of data storage device 110 are omitted for clarity in FIG. 1, such as preamps, transceivers, processors, amplifiers, motors, servos, armatures, enclosures, and other electrical and mechanical elements.

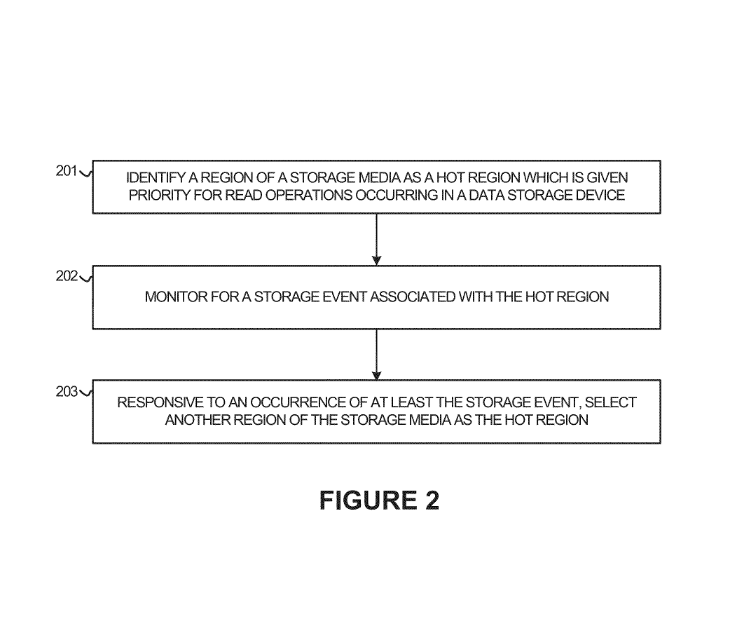

To further illustrate the operation of data system 100, FIG. 2 is provided. FIG. 2 is a flow diagram illustrating a method of operating data storage device 110. The operations of FIG. 2 are referenced below parenthetically. In FIG. 2, storage control system 120 identifies (201) a region of storage media 111 as a hot region which is given priority for read operations occurring in data storage device 110. In FIG. 1, the hot region is indicated by a first of regions 113, namely region ‘1’ in FIG. 1. The current hot region is a region of storage media 111 which is given priority for at least read operations, while other regions are not given priority for read operations. In further examples, both read operations and write operations are prioritized in the hot region.

Giving priority for read operations can comprise keeping R/W head 112 over a current hot region during at least idle times of data storage device 110. The current hot region can also be used for incoming write data instead of other regions of storage media 111. In this manner, incoming write data is sequentially written to the current hot region, i.e. region 1, and movement of R/W head 112 is limited to a sub-portion of storage media 111. In some examples, unless a read or write transaction is intended for a specific region outside of region 1, then R/W head 112 is configured to linger over region 1. In examples of rotating storage media, such as a hard disk drive, R/W head 112 is prioritized to a ‘ring’ of blocks as a restricted range over the rotating storage media that defines region 1, and R/W head 112 is positioned over region 1 when read or write transactions are not presently being performed. In further examples, giving priority for read operations occurring in data storage device 110 includes returning a position of read/write head 112 for storage media 111 to the hot region upon completion of any storage transactions on storage media 111.

Storage control system 120 monitors (202) for a storage event associated with the hot region. The storage event can include a storage condition such as a fullness level of the hot region, or a quantity of storage blocks that are used to store data presently. For example, incoming write transactions can be grouped into region 1, and once region 1 fills up or exceeds a fullness threshold the storage event can be considered to have occurred, and region 1 should be changed. Monitoring for the storage event can include monitoring a current storage block where incoming write data is written. For example, incoming write data can be sequentially written to region 1, and even if already-written data is marked as old or replaced in region 1, a current storage location can continue to be incremented for further write data. Once the current storage location reaches a predetermined location, such as a predetermined end block, then occurrence of the storage event can indicate that the current hot region should be changed.

Responsive to occurrence of at least the storage event, storage control system 120 selects (203) another region of the storage media as the hot region. Once the storage event indicates that another region of the storage media should be selected as the hot region, then storage control system 120 selects a different region of storage media 111 as the hot region. Specifically, in FIG. 1, region 2 is used as the hot region after the storage event indicates that region 1 should no longer be used as the hot region. This region 2 is then designated as a region of storage media 111 which is given priority for read operations. Write operations can also be given priority for the hot region. Previous region 1 is no longer designated as a region of storage media 111 that receives prioritized read operations. Further hot regions can be designated in a subsequent manner as described for the transition from region 1 to region 2.

In further examples, a command transferred from host system 140 to data storage device 110 can be monitored as the storage event which indicates to change the hot region to another region. The command can indicate a specific region to designate as the new hot region, or the command can indicate to change the hot region to another region selected by storage control system 120.

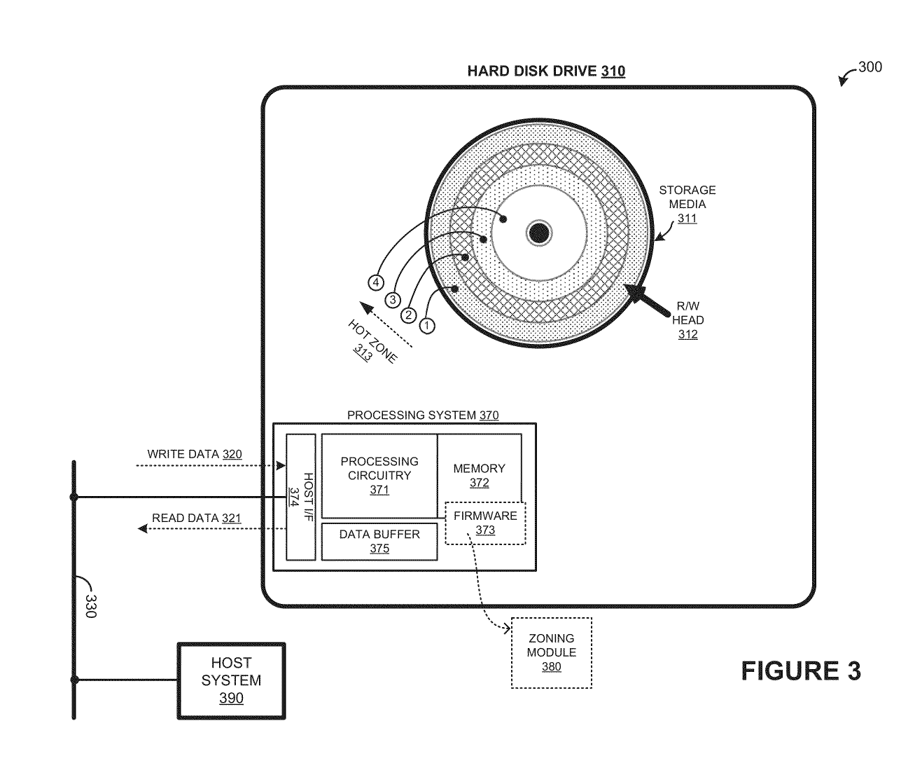

As a further example data storage system employing a data storage drive, FIG. 3 is presented. FIG. 3 is a system diagram illustrating data storage system 300. Data storage system 300 includes hard disk drive (HDD) 310 and host system 390. HDD 310 and host system 390 communicate over storage link 330. Various elements of HDD 310 can be included in data storage device 110 of FIG. 1, although variations are possible.

Storage link 330 can include one or more links, although a combined link is sown in FIG. 3. Storage link 330 can comprise any storage or disk interface, such as Serial Attached ATA (SATA), Serial Attached SCSI (SAS), FibreChannel, Universal Serial Bus (USB), SCSI, InfiniBand, Peripheral Component Interconnect Express (PCIe), Ethernet, Internet Protocol (IP), or other parallel or serial storage or peripheral interfaces, including variations and combinations thereof.

Host system 390 can include one or more computing and network systems, such as personal computers, servers, cloud storage systems, packet networks, management systems, or other computer and network systems, including combinations and variations thereof. In operation, host system 390 issues read and write commands to HDD 310 over storage link 330.

HDD 310 includes storage media 311, R/W head 312, and processing system 370. Processing system 370 includes processing circuitry 371, memory 372, host interface (I/F) 374, and data buffer 375. It should be understood that other components of HD 310 are omitted for clarity in FIG. 3, such as preamps, amplifiers, motors, servos, armatures, enclosures, and other electrical and mechanical elements. In some examples, HDD 310 comprises only a rotating magnetic media as storage media 311, while in other examples, HDD 310 comprises a hybrid drive including rotating magnetic media and solid state memory elements. Furthermore, processing system 370 includes firmware 373 which includes zoning module 380 which, when executed by at least processing circuitry 371, allows for at least establishing variable host zones and cold zones on storage media 311.

Host interface 374 includes one or more storage interfaces for communicating with host systems, networks, and the like. Host interface 374 can comprise transceivers, interface circuitry, connectors, buffers, microcontrollers, and other interface equipment.

Buffer 375 includes one or more non-transitory computer readable memory elements. Buffer 375 can include RAM, SRAM, flash memory, magnetic RAM, phase change memory, among other memory technologies. Buffer 375 is employed as a temporary storage location for operations received over host interface 374. Buffer 375 stores one or more Input/Output Operations (IOPs) for handling by HDD 310. For example, buffer 375 is configured to store read or write commands received over link 330 for processing by processing system 370. Buffer 375 can be included in elements of host interface 374, processing circuitry 371, or memory 372. In some examples, buffer 375 is included in separate elements.

Processing system 370 also includes processing circuitry 371 and memory 372. Processing circuitry 371 can comprise one or more microprocessors and other circuitry that retrieves and executes firmware 373 from memory 372. Processing circuitry 371 can be implemented within a single processing device but can also be distributed across multiple processing devices or sub-systems that cooperate in executing program instructions. Examples of processing circuitry 371 include general purpose central processing units, application specific processors, and logic devices, as well as any other type of processing device, combinations, or variations thereof.

Memory 372 can comprise any non-transitory computer readable storage media readable by processing circuitry 371 and capable of storing firmware 373. Memory 372 can include volatile and nonvolatile, removable and non-removable media implemented in any method or technology for storage of information, such as computer readable instructions, data structures, program modules, or other data. In addition to storage media, in some implementations memory 372 can also include communication media over which firmware 373 can be communicated. Memory 372 can be implemented as a single storage device but can also be implemented across multiple storage devices or sub-systems co-located or distributed relative to each other. Memory 372 can comprise additional elements, such as a controller, capable of communicating with processing circuitry 371. Examples of storage media include random access memory, read only memory, magnetic disks, hybrid magnetic-solid state drives, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof, or any other type of storage media.

Firmware 373 and zoning module 380 can be implemented in program instructions and among other functions can, when executed by HDD 310 in general or processing circuitry 371 in particular, direct HDD 310 or processing circuitry 371 to operate as described herein. Firmware 373 and zoning module 380 can include additional processes, programs, or components, such as operating system software, database software, or application software. Firmware 373 and zoning module 380 can also comprise software or some other form of machine-readable processing instructions executable by processing circuitry 371. In at least one implementation, the program instructions can include first program instructions that direct processing system 370 to identify a region of the storage media as a hot region having at least prioritized read operations for the data storage device, monitor at least a storage event associated with the hot region, and responsive to occurrence of at least the storage event, change the hot region to another region of the storage media, among other operations.

In general, firmware 373 and zoning module 380 can, when loaded into processing circuitry 371 and executed, transform processing circuitry 371 overall from a general-purpose computing system into a special-purpose computing system customized to operate as described herein. Encoding firmware 373 and zoning module 380 on memory 372 can transform the physical structure of memory 372. The specific transformation of the physical structure can depend on various factors in different implementations of this description. Examples of such factors can include, but are not limited to the technology used to implement the storage media of memory 372 and whether the computer-storage media are characterized as primary or secondary storage. For example, if the computer-storage media are implemented as semiconductor-based memory, firmware 373 and zoning module 380 can transform the physical state of the semiconductor memory when the program is encoded therein. For example, firmware 373 and zoning module 380 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

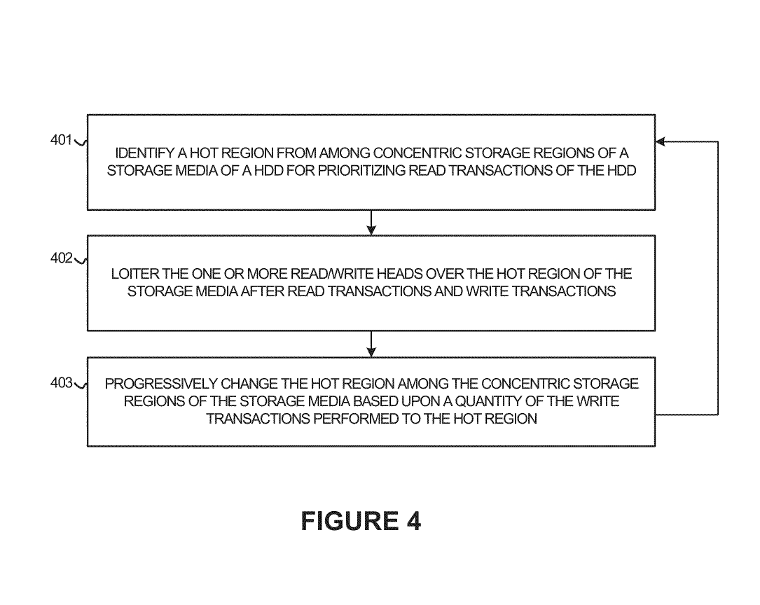

To further illustrate the operation of system 300 and HDD 310, FIG. 4 is presented. FIG. 4 is a flow diagram illustrating a method of operation of HDD 310. The operations of FIG. 4 are referenced below parenthetically. In FIG. 4, zoning module 380 identifies (401) hot zone 313 from among concentric storage regions of a storage media of a HDD for prioritizing read transactions of the HDD. Zoning module 380 instructs HDD 310 to loiter (402) the one or more read/write heads over the hot region of the storage media after read transactions and write transactions.

As seen in FIG. 3, several zones are included on storage media 311. These zones can include concentric regions as seen in FIG. 3, but can be defined in various ways. In a first way, the zones can be a predetermined storage size of consecutive storage blocks, such as a predetermined number of megabytes or gigabytes of consecutive storage blocks. In other examples, the zones can be defined by geometry, such as predetermined angular ranges that R/W head 312 is restricted to sweep over storage media 311. Other definitions of the zones can be established, including combinations thereof. The zones can have the same storage size as each other, or can vary depending upon a location along the radius of storage media 311. Likewise, geometrically-defined zones can have the same angular range for R/W head 312 as each other, or can vary to maintain a constant storage size. In examples that include rotating storage media, such as HDD 310, the various zones or regions of the storage media each comprise generally circular bands of storage blocks. Each zone is concentric to each other, with zones of larger mean radius located nearer to the outer edge of the storage media than zones of smaller mean radius.

In other examples, more than one read/write head is employed, such as when multiple platters are employed in a HDD and each face or side of a platter has a corresponding R/W head. In these examples, at least one read/write head can be positioned across the storage media to handle storage transactions associated with data, and the hot region comprises a sub-portion of the storage media to constrain the positioning of the at least one read/write head for the storage transactions.

Once the zones are established, a first of the zones is designated as a “hot zone” which receives prioritized treatment for storage transactions of HDD 310. In some examples, an outermost zone is established as the hot zone first, with subsequent hot zones designated as zones inside or closer to an inner portion of storage media 311. As shown in FIG. 3, a first zone ‘1’ is initially designated as hot zone 313. Other zones not designated as hot zones can be referred to as ‘cold zones’ or used for ‘cold storage’ of data stored therein. It should be understood that the hot zone can span more than one of the zones of storage media 311, or can partially overlap one or more of the zones of storage media 311.

The prioritized treatment for hot zone 313 can include various ways to establish faster or lower latency access to data stored by HDD 310, such as prioritized read access, prioritized write access, or loitering of R/W head 312 over the hot zone, among other prioritization techniques, including combinations thereof. In loitering examples, R/W head 312 is always returned to a position over hot zone 313 after storage transactions. The loitering of R/W head 312 over the hot region can include loitering R/W head 312 when HDD 310 is idle. For example, a write might occur to any storage block on storage media 311, but after the write is complete, then R/W head 312 is repositioned over hot zone 313. In other examples, both reads and writes are restricted to hot zone 313. In these examples, incoming write data is written on storage media 311 within hot zone 313, thus restricting the movement of R/W head 312 to within the range on storage media 311 defined by the current hot zone. Since R/W head 312 loiters over hot zone 313, or is continually returned to be positioned over hot zone 313, then access to data written in hot zone 313 experiences lower latency and lower seek times, among other performance increases.

However, hot zone 313 might become full of data, such as due to enough sequential writes to hot zone 313. These may be established a storage threshold, such as a quantity of data stored in the current hot zone, such as zone 1. Once this storage threshold is reached, then data in the current hot zone might be overwritten or storage drive might be considered full. Advantageously, in the examples discussed herein, the defined hot zone is able to be changed based on occurrences of storage events. For example, a quantity of writes to the current hot zone can be monitored by zoning module 380, and when the quantity crosses a threshold quantity, then the current hot zone can be considered to be full and a new hot zone can be identified. In other examples, writes occur in a sequential manner to the current hot zone, and once a threshold amount of writes have occurred, then the current hot zone can be considered full and a new hot zone identified. Other conditions and events for establishing when to change the current hot zone can be monitored, such as time limits for written data. In timed examples, the current hot zone can be designated as a hot zone for a specific amount of time, and once the time has expired, then a new hot zone can be established. In other examples, when a time of the last-written data exceeds a time threshold, then a new hot zone can be established. It should be understood that other examples for changing the hot zone to another zone on a storage medium can be established, including combinations of the various examples herein.

However, in this example, a quantity of write transactions is monitored for hot zone 313 during operation of HDD 310. Writes, such as associated with write data 320, can be monitored for when a predetermined amount of writes have occurred. This predetermined amount can be indicative of zone 1 filling up with data, or can indicate when an address range of zone 1 is exceeded. Zoning module 380 can tailor the number of writes to prevent a specific write transaction from spanning a zone boundary, such as spanning from zone 1 to zone 2. Zoning module 380 might be configured to change the hot zone according to a size of a write transaction responsive to the associated write transaction to avoid spanning a zone boundary with the write transaction.

Once the storage event indicates that the hot zone should be changed, then zoning module 380 can identify another zone on storage media 311 as the hot zone. Over time, zoning module 380 progressively changes (403) the hot region to successive concentric storage regions of storage media 311 based upon a quantity of the write transactions performed to the currently designated hot region. This process outlined in operations 401-403 can be repeated as data is written to HDD 310 to progressively change the hot region according to the storage events.

Various thresholds can be established for changing the hot zone to different regions of storage media 311. Zoning module 380 can be configured to compare the fullness of the current hot zone against a fullness threshold, and responsive to at least the fullness exceeding the fullness threshold, zoning module 380 can be configured to change the hot region to the other region. In other examples, zoning module 380 can be configured to compare a quantity of write transactions to a threshold and responsively change the hot zone to another region of storage media 311 when the quantity of write transactions exceeds the threshold.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A data storage device configured to store and retrieve data, the data storage device comprising:
storage media that stores the data;
a storage control system configured to identify a region of the storage media as a hot region which is given priority for read operations occurring in the data storage device;
the storage control system configured to monitor for a storage event associated with the hot region;
responsive to an occurrence of at least the storage event, the storage control system configured to select another region of the storage media as the hot region.

2. The data storage system of claim 1, wherein in the storage media comprises a rotating magnetic storage media, wherein the hot region comprises a first sequential set of storage blocks that define a first generally circular band of the rotating magnetic storage media, and wherein the other region comprises a second sequential set of storage blocks that define a second generally circular band of the rotating magnetic storage media concentric with the first generally circular band.

3. The data storage system of claim 1, comprising:
at least one read/write head that can be positioned across the storage media to handle storage transactions associated with the data, wherein the hot region comprises a sub-portion of the storage media to constrain the positioning of the at least one read/write head for the storage transactions.

4. The data storage system of claim 3, wherein constraining the positioning of the at least one read/write head for the storage transactions comprises loitering the at least one read/write head over the hot region when the data storage system is idle.

5. The data storage system of claim 3, wherein constraining the positioning of the at least one read/write head for the storage transactions comprises storing incoming write transactions within the hot region.

6. The data storage system of claim 1, comprising:
the storage control system configured to monitor a fullness of the hot region to monitor for the occurrence of the storage event; and
the storage control system configured to compare the fullness of the hot region against a fullness threshold, and responsive to at least the fullness exceeding the fullness threshold the storage control system configured to select the other region as the hot region.

7. The data storage system of claim 1, comprising:
the storage control system configured to monitor a quantity of write transactions to the hot region to monitor for the occurrence of the storage event, and comprising:
the storage control system configured to compare the quantity of the write transactions to a threshold and responsively select the other region as the hot region when the quantity of the write transactions exceeds the threshold.

8. The data storage system of claim 1, comprising:
the storage control system configured to monitor for a command transferred by a host system to change the hot region, and select the other region as the hot region responsive to the command.

9. The data storage system of claim 1, wherein priority for the read operations occurring in the data storage device comprises returning a position of a read/write head for the storage media to the hot region upon completion of storage transactions to the storage media.

10. A method of operating a data storage device configured to store and retrieve data, the method comprising:
storing the data on storage media;
identifying a region of the storage media as a hot region which is given priority for at least write operations occurring in the data storage device;
monitoring for a storage event associated with the hot region;
responsive to an occurrence of at least the storage event, selecting another region of the storage media as the hot region.

11. The method of claim 10, wherein in the storage media comprises a rotating magnetic storage media, wherein the hot region comprises a first sequential set of storage blocks that define a first generally circular band of the rotating magnetic storage media, and wherein the other region comprises a second sequential set of storage blocks that define a second generally circular band of the rotating magnetic storage media concentric with the first generally circular band.

12. The method of claim 10, further comprising:
positioning at least one read/write head across the storage media to handle storage transactions associated with the data, wherein the hot region comprises a sub-portion of the storage media to constrain the positioning of the at least one read/write head for the storage transactions.

13. The method of claim 12, wherein constraining the positioning of the at least one read/write head for the storage transactions comprises loitering the at least one read/write head over the hot region when the data storage system is idle.

14. The method of claim 12, wherein constraining the positioning of the at least one read/write head for the storage transactions comprises storing incoming write transactions within the hot region.

15. The method of claim 10, further comprising:
monitoring a fullness of the hot region to monitor for the occurrence of the storage event;
comparing the fullness of the hot region against a fullness threshold; and
selecting the other region as the hot region responsive to at least the fullness exceeding the fullness threshold.

16. The method of claim 10, further comprising:
monitoring a quantity of the write transactions to the hot region to monitor for the occurrence of the storage event;
comparing the quantity of the write transactions to a threshold; and
selecting the other region as the hot region responsive to the quantity of the write transactions exceeding the threshold.

17. The method of claim 10, further comprising:
monitoring for a command transferred by a host system to change the hot region to monitor for the occurrence of the storage event; and
selecting the other region as the hot region responsive to the command.

18. The method of claim 10, wherein priority for the write operations occurring in the data storage device comprises returning a position of a read/write head for the storage media to the hot region upon completion of storage transactions to the storage media.

19. A hard disk drive, comprising:
rotating magnetic storage media configured to store data;
one or more read/write heads positioned over the storage media and configured to at least write the data to the storage media and read the data from the storage media;
a storage control system configured to identify a hot region from among a plurality of concentric storage regions of the storage media for prioritizing read transactions of the hard disk drive by at least loitering the one or more read/write heads over the hot region of the storage media after at least the read transactions and write transactions;
the storage control system configured to change the hot region among the plurality of concentric storage regions of the storage media based upon at least a quantity of the write transactions performed to the hot region.

20. The hard disk drive of claim 19, wherein the quantity of the write transactions performed to the hot region indicate a fullness of the hot region, and comprising:
the storage control system configured to compare the fullness of the hot region against a fullness threshold; and
the storage control system configured to progressively change the hot region among the plurality of concentric storage regions of the storage media responsive to at least the fullness exceeding the fullness threshold.
